(19) United States
(12) Patent Application Publication
(10) Pub. No.: US 2008/0140931 A1
(43) Pub. Date: Jun. 12, 2008

(54) Disk array system, disk array method, and computer product

(75) Inventors: Daiya Nakamura, Kawasaki (JP); Atsuhiro Otaka, Kawasaki (JP); Hidetoshi Satou, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/905,142

(22) Filed: Sep. 27, 2007

(30) Foreign Application Priority Data
Dec. 8, 2006 (JP) 2006-332539

(51) Int. Cl. G06F 12/00

(52) U.S. Cl. 711/114; 711/E12.001

(57) ABSTRACT

A disk enclosure issues various small computer system interface (SCSI) commands to hard disk drives (HDDs), and acquires and stores therein disk detail data on all the HDDs. A disk controller is connected to the disk enclosure via an exclusive SCSI cable and the disk controller issues the SCSI command for requesting the disk detail data in batch. Upon receiving the SCSI command, the disk enclosure returns the disk detail data on all the HDDs in batch, in response to the SCSI command.

### BACKGROUND OF THE INVENTION

1. Field of the Invention

The present invention relates to a disk array system, a disk array method, and a computer product.

2. Description of the Related Art

Recently, a data storage device has been required to have a larger data capacity, a faster access speed, and more reliable data storage. Technologies related to a disk array system working as such a data storage device are disclosed, for example, in Japanese Patent Application Laid-Open Nos. 2003-150319 and 2005-222429.

The disk array system generally includes a disk enclosure that is a chassis housing a plurality of disk devices and a controller that entirely controls the system.

The controller communicates with the disk enclosure to maintain or construct an optimum system, and issues a small computer system interface (SCSI) command to the disk enclosure. The disk enclosure performs various self-managements such as monitoring the hardware status, the temperature, and the power supply and operating hardware components by using a processor. The optimum system is maintained by using instructions for acquiring data or performing various operations issued not by the disk enclosure itself but by an external device, for example, by the controller issuing various SCSI commands (inquiry command, send diagnostic command, etc.) to the processor of the disk enclosure.

To construct the optimum system, for example, when communication between the controller and the disk enclosure initiates, the controller issues an SCSI command to each of the disk devices of the disk enclosure to acquire detail data on the disk devices, and constructs the optimum system based on the acquired disk detail data.

In the above disk array system, because the controller is required to issue the SCSI command to all the disk devices of the disk enclosure for acquiring the detail data on the disk devices, with the increase in the number of the disk devices the process of issuing the SCSI command becomes more complex, which results in increasing of time for constructing the optimum system.

### SUMMARY OF THE INVENTION

It is an object of the present invention to at least partially solve the problems in the conventional technology.

According to an aspect of the present invention, a disk array system includes a disk enclosure that houses a plurality of disk devices; and a disk controller that controls reading of data from and writing of data to the disk devices, wherein the disk controller and the disk enclosure communicate with each other via a first communication path, the disk enclosure includes an acquiring unit that issues a first command to each of the disk devices, and receives disk detail data from each of the disk devices in response to the first command via a first communication path; a storage unit that stores therein the disk detail data; and a returning unit that returns the disk detail data stored in the storage unit in batch in response to a second command received from the disk controller, and the disk controller including a command issuing unit that issues the second command to the disk enclosure.

According to another aspect of the present invention., a disk array system includes a disk enclosure that houses a plurality of disk devices; and a disk controller that controls reading of data from and writing of data to the disk devices, wherein the disk controller and the disk enclosure communicate with each other by using various small computer system interface (SCSI) commands via a first communication path, the disk enclosure includes an acquiring unit that issues a first SCSI command to each of the disk devices, and receives disk detail data from each of the disk devices in response to the first SCSI command; a storage unit that stores therein the disk detail data; and a returning unit that returns the disk detail data in batch in response to a second SCSI command received from the disk controller, and the disk controller including a command issuing unit that issues the second SCSI command to the disk enclosure.

According to still another aspect of the present invention, a method of controlling a disk enclosure and a disk controller, the disk enclosure housing a plurality of disk devices, and the disk controller controlling reading of data from and writing of data to the disk devices, wherein the disk controller and the disk enclosure communicate with each other via a first communication path, wherein the disk enclosure performs issuing a first command to each of the disk devices, and receiving disk detail data from each of the disk devices in response to the first command via a first communication path; storing the disk detail data in a storage unit; and returning the disk detail data stored in the storage unit in batch in response to a second command received from the disk controller, and the disk controller performs issuing the second command to the disk enclosure.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A to 1C are schematic diagrams for explaining an overview and features of a disk array system according to a first embodiment of the present invention;

FIG. 2 is a functional block diagram of the disk array system shown in FIGS. 1A to 1C;

FIG. 3 is a flowchart of a process performed by a disk enclosure shown in FIG. 2 before the disk array system is not constructed;

FIG. 4 is a flowchart of a process performed by the disk enclosure after the disk array system is constructed;

FIG. 5 is a functional block diagram of a disk array system according to a second embodiment of the present invention;

FIG. 6 is a functional block diagram of a disk array system according to a third embodiment of the present invention;

FIG. 7 is a flowchart of a process performed by a disk enclosure shown in FIG. 6;

FIG. 8 is a flowchart of a process performed by a disk controller shown in FIG. 6; and

FIG. 9 is a functional block diagram of a computer that executes a disk array program.

### DETAILED DESCRIPTION OF THE PREFERRED EMBODIMENTS

Exemplary embodiments of the present invention are described in detail below with reference to the accompanying drawings.

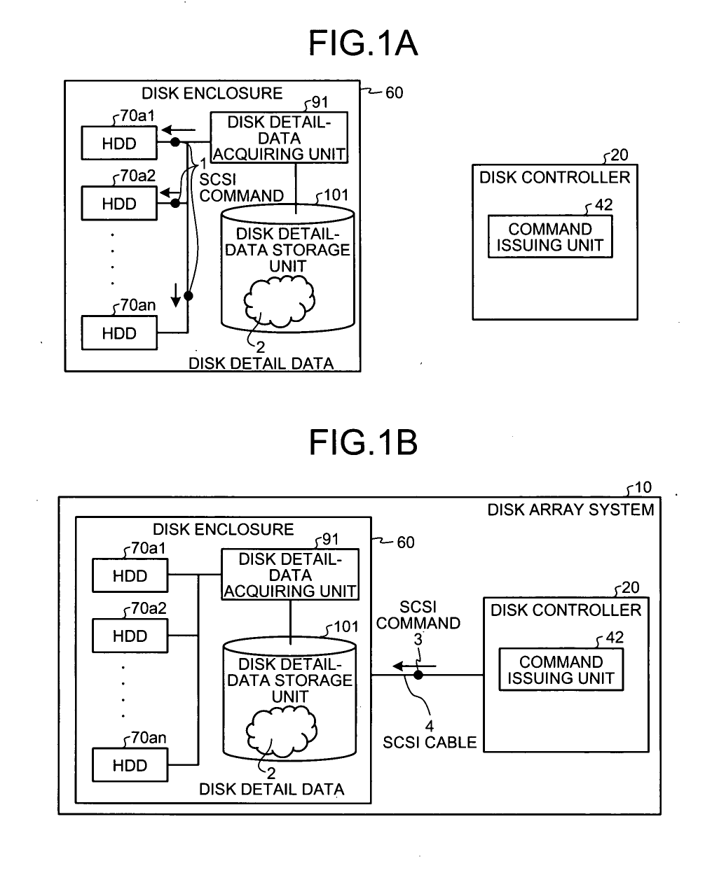

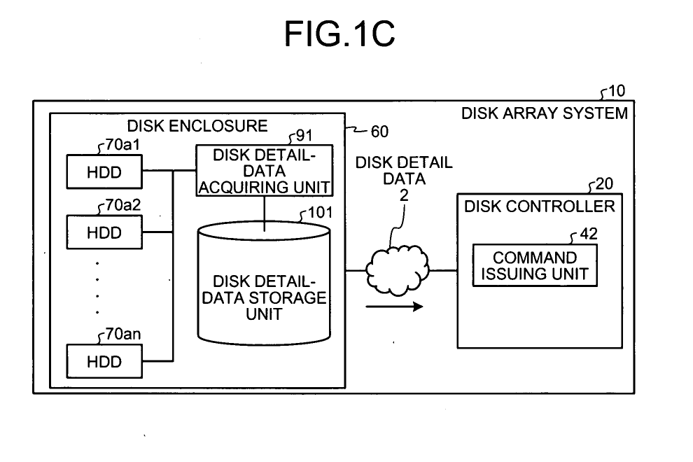

The overview and the features of the disk array system according to the first embodiment are explained with reference to FIGS. 1A to 1C. FIGS. 1A to 1C are schematic diagrams for explaining the overview and the features of the disk array system according to the first embodiment.

The disk array system according to the first embodiment includes a disk enclosure and a disk controller, the disk controller controls reading of data from or writing to a plurality of disk devices of the disk enclosure, and communication between the disk enclosure and the disk controller is made by using various SCSI commands, which makes it possible to construct an optimum system in a short time.

The features of the disk array system are explained in detail below. As shown in FIG. 1A, a disk array system 10 includes a disk enclosure 60 and a disk controller 20. The disk enclosure 60 issues an SCSI command to each of hard disk drives (HDDs) 70a1 to 70an, acquires disk detail data from each of the HDDs 70a1 to 70an, and stores therein the disk detail data. The HDDs 70a1 to 70an correspond to “plurality of disk devices” described in the claims.

To be specific, the disk enclosure 60 issues an SCSI command 1 such as an inquiry command or a send diagnostic command to the HDDs 70a1 to 70an by using a disk detail-data acquiring unit 91. Upon receiving the disk detail data (for example, a support transfer rate (byte per second), a vendor name, and a model name) from each of the HDDs 70a1 to 70an, the disk enclosure 60 stores the disk detail data (hereinafter, “disk detail data 2”) in a disk detail-data storage unit 101. It is unnecessary, at the state shown in FIG. 1A, that the disk enclosure 60 is connected to the disk controller 20, that is, the disk array system is not be constructed.

As shown in FIG. 1B, the disk controller 20 issues an SCSI command for requesting the disk detail data on the HDDs 70a1 to 70an in batch to the disk enclosure 60.

To be specific, when the disk controller 20 and the disk enclosure 60 can communicate with each other by connecting the disk controller 20 to the disk enclosure 60 via an SCSI cable 4 for exclusive use, a command issuing unit 42 of the disk controller 20 issues an SCSI command 3 for requesting the disk detail data 2 on the HDDs 70a1 to 70an in batch to the disk enclosure 60. Although the disk array system 10 is constructed in the state shown in FIG. 1B, the optimum system is not constructed.

As shown in FIG. 1C, the disk enclosure 60 returns the disk detail data on the HDDs 70a1 to 70an in batch to the disk controller 20 in response to the SCSI command issued by the disk controller 20.

To be specific, upon receiving the SCSI command 3 that is issued by the command issuing unit 42 of the disk controller 20, the disk enclosure 60 returns the disk detail data 2 on the HDDs 70a1 to 70an that is stored in the disk detail-data storage unit 101 in batch to the disk controller 20. Upon receiving the disk detail data 2 on the HDDs 70a1 to 70an, the disk controller 20 constructs the disk array system 10 in an optimum state based on the disk detail data 2.

As a result, regardless of the number of the disk devices, the disk array system 10 can acquire the detail data on the disk devices using the simple process, which makes it possible to construct the optimum system in a short time.

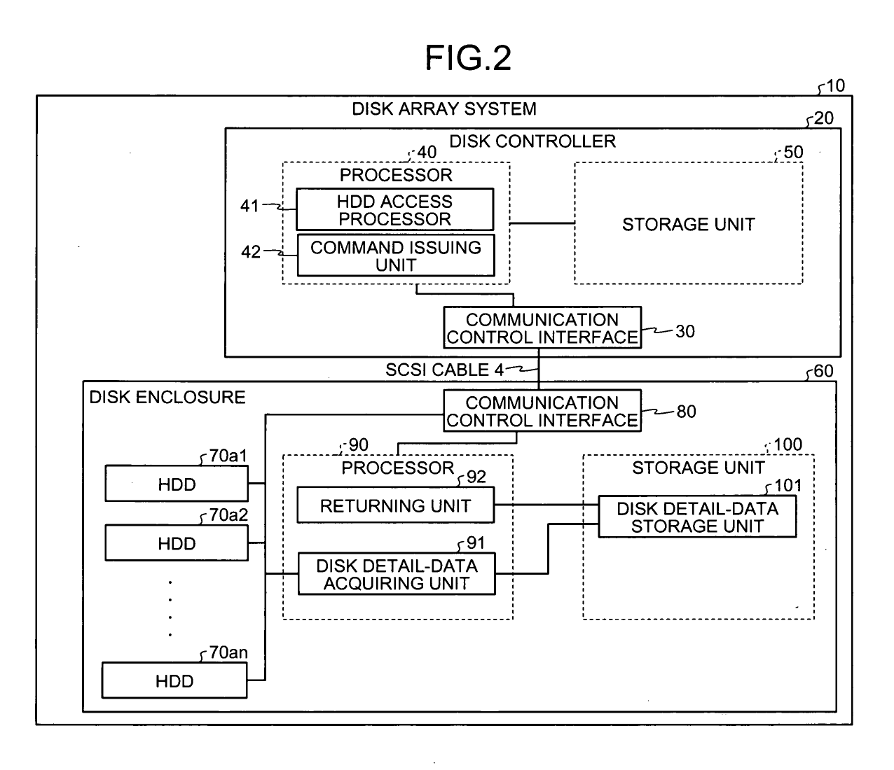

The structure of the disk array system 10 is explained below with reference to FIG. 2. FIG. 2 is a functional block diagram of the disk array system 10. As shown in FIG. 2, the disk array system 10 includes the disk controller 20 and the disk enclosure 60, both connected to each other via the SCSI cable 4.

The disk controller 20 controls the disk array system 10 in such a manner that the disk array system 10 works as a storage device to or from which an external data processor can write or read data. The disk controller 20 includes a communication control interface 30 that controls communication with a communication control interface 80 of the disk enclosure 60, a processor 40, and a storage unit 50 that stores therein data used for various processes performed by the processor 40.

The processor 40 controls the disk controller 20 to perform various processes. The processor 40 includes an HDD access processor 41 that writes data to or reads data from the HDDs 70a1 to 70an of the disk enclosure 60 and the command issuing unit 42. The command issuing unit 42 corresponds to “command issuing unit” described in the claims.

The command issuing unit 42 issues the SCSI command for requesting the disk detail data on the HDDs 70a1 to 70an in batch to the disk enclosure 60. To be specific, when the disk controller 20 is switched on in a state that the communication between the disk controller 20 and the disk enclosure 60 is established, that is, the disk controller 20 is connected to the disk enclosure 60 via the SCSI cable 4 (or when a predetermined operation is performed after the disk controller 20 is switched on), the command issuing unit 42 issues the SCSI command for requesting the disk detail data on the HDDs 70a1 to 70an in batch to the disk enclosure 60.

The disk enclosure 60 includes the HDDs 70a1 to 70an, the communication control interface 80 that controls communication with the communication control interface 30 of the disk controller 20, a processor 90, and a storage unit 100.

The HDDs 70a1 to 70an write data to a built-in disk using a magnetic head, and read the written data from the disk. To be specific, when the disk controller 20 specifies a location to write data in the disk, the HDDs 70a1 to 70an receive the data, and write and save the data in the specified location. If the disk controller 20 specifies the location for reading the data from the disk, the HDDs 70a1 to 70an read the data from the specified location and output the data to the disk controller 20.

Each of the HDDs 70a1 to 70an has the disk detail data unique thereto. The disk detail data contains, for example, the support transfer rate (byte per second), the vendor name, and the model name.

In addition to performing the various processes by controlling the disk enclosure 60, the processor 90 performs various management processes for the disk enclosure 60 such as monitoring the hardware status, the temperature, and the voltage and operating the hardware components. The processor 90 includes the disk detail-data acquiring unit 91 and a returning unit 92. The disk detail-data acquiring unit 91 and the returning unit 92 correspond to “acquiring unit” and “returning unit” described in the claims, respectively.

The disk detail-data acquiring unit 91 issues the SCSI command to each of the HDDs 70a1 to 70an to acquire the disk detail data, that is, various data on the HDDs 70a1 to 70an. To be specific, when the disk enclosure 60 is switched on (or the predetermined operation is performed after the disk enclosure 60 is switched on), the disk detail-data acquiring unit 91 issues the SCSI command, such as an inquiry command or a send diagnostic command, to each of the HDDs 70a1 to 70an to acquire the disk detail data, such as the support transfer rate (byte per second), the vendor name, and the model name, and stores the disk detail data in the disk detail-data storage unit 101 later explained.

In response to the SCSI command issued by the disk controller 20, the returning unit 92 returns the disk detail data on the HDDs 70a1 to 70an in batch to the disk controller 20. To be specific, when the disk enclosure 60 receives the SCSI command for requesting the disk detail data on the HDDs 70a1 to 70an in batch from the command issuing unit 42 of the disk controller 20, the disk detail-data acquiring unit 91 reads the disk detail data stored in the disk detail-data storage unit 101, and the returning unit 92 returns the disk detail data in batch to the disk controller 20.

The storage unit 100 stores therein the data used for the various processes performed by the processor 90. The storage unit 100 includes the disk detail-data storage unit 101. The disk detail-data storage unit 101 corresponds to “storage unit” described in the claims.

The disk detail-data storage unit 101 stores therein the disk detail data that is acquired by the disk detail-data acquiring unit 91. The disk detail-data storage unit 101 receives the disk detail data, such as the support transfer rate (byte per second), the vendor name, and the model name of each of the HDDs 70a1 to 70an from the disk detail-data acquiring unit 91, and stores therein the disk detail data.

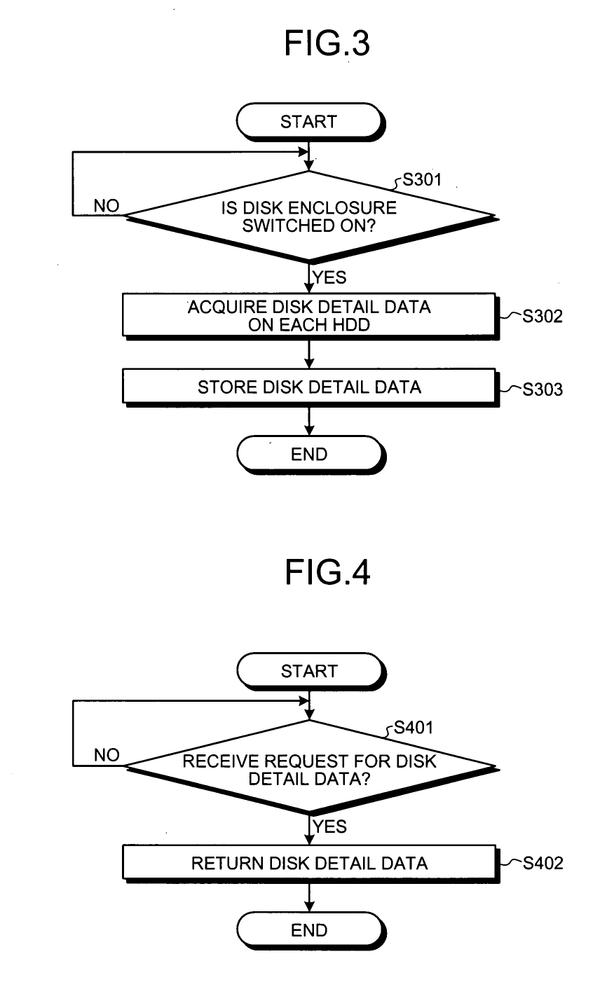

The processes performed by the disk enclosure 60 are explained with reference to FIGS. 3 and 4. FIG. 3 is a flowchart of the process performed by the disk enclosure 60 before the disk array system 10 is constructed. FIG. 4 is the flowchart of the processes performed by the disk enclosure 60 after the disk array system 10 is constructed.

Firstly, the process performed by the disk enclosure 60 before the disk array system 10 is constructed is explained with reference to FIG. 3. In the disk enclosure 60, when the disk enclosure 60 is switched on (or the predetermined operation is performed after the disk enclosure 60 is switched on) (Yes at step S301), the disk detail-data acquiring unit 91 issues the SCSI command to each of the HDDs 70a1 to 70an to receive the disk detail data from each of the HDDs 70a1 to 70an (step S302). After the disk detail data is stored in the disk detail-data storage unit 101 (step S303), the process control goes to end.

Then, the process performed by the disk enclosure 60 after the disk array system 10 is constructed is explained with reference to FIG. 4. Upon the disk enclosure 60 receiving the SCSI command for requesting the disk detail data from the disk controller 20, (Yes at step S401), the returning unit 92 returns the disk detail data on the HDDs 70a1 to 70an stored in the disk detail-data storage unit 101 to the disk controller 20 (step S402), and the process control goes to end.

According to the first embodiment, the disk enclosure issues the SCSI command to each of the HDDs to acquire the disk detail data, that is, the various data on the HDDs, and stores therein the disk detail data. If the disk controller issues the SCSI command for requesting the disk detail data on the HDDs in batch to the disk enclosure, the disk enclosure returns the disk detail data on the HDDs in response to the SCSI command. This makes it possible to acquire the disk detail data on all of the HDDs using the simple process regardless of the number of the HDDs, and to construct the optimum system within a short time.

In the first embodiment, the disk controller and the disk enclosure are connected to each other only via the SCSI cable. However, according to a second embodiment of the present invention, the disk controller and the disk enclosure are connected to each other via another communication cable in addition to the SCSI cable.

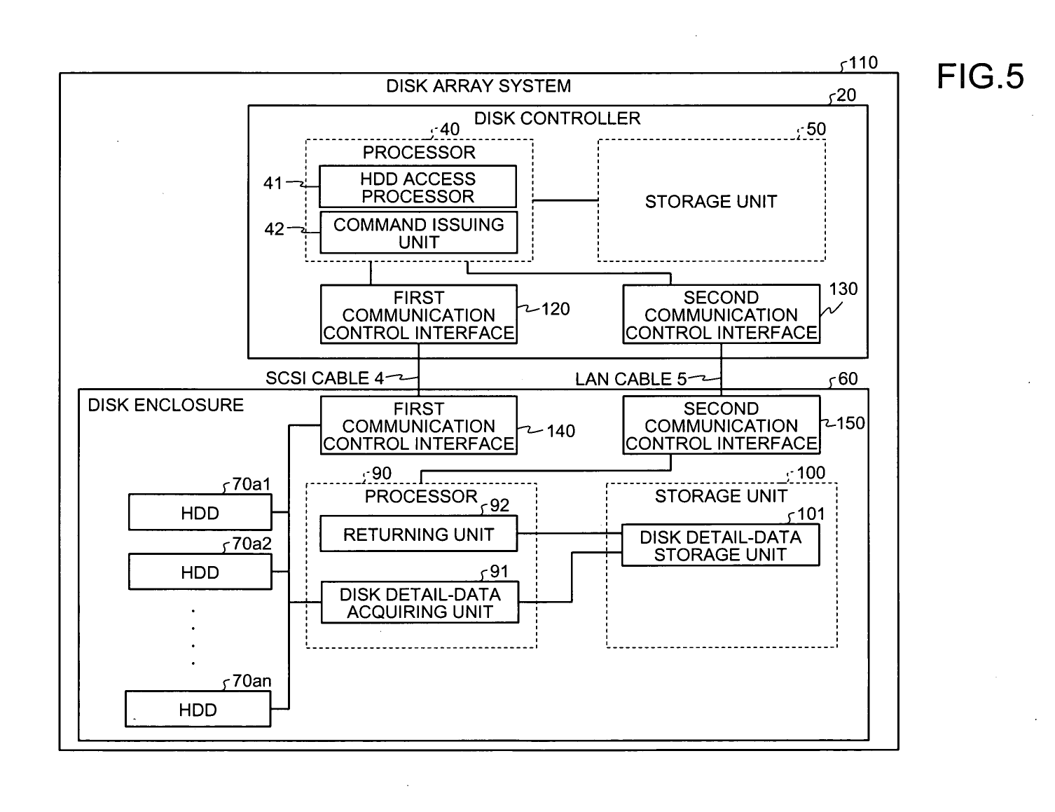

FIG. 5 is a functional block diagram of a disk array system 110 according to the second embodiment. The disk controller 20 and the disk enclosure 60 are connected to each other via the SCSI cable 4 and a local area network (LAN) cable 5 in the disk array system 110.

The disk controller 20 controls the disk array system 110 in such a manner that the disk array system 110 works as a storage device to or from which an external data processor can write or read data. The disk controller 20 includes a first communication control interface 120, a second communication control interface 130, the processor 40 that includes the HDD access processor 41 and the command issuing unit 42, and the storage unit 50 that stores therein data used for the various processes performed by the processor 40. Same numerals are assigned to units performing operations similar to those according to the first embodiment. The explanation for such units is not repeated, and only the HDD access processor 41, the first communication control interface 120, the command issuing unit 42, and the second communication control interface 130 are explained below (the HDD access processor 41 and the command issuing unit 42 are briefly explained).

The HDD access processor 41 writes data to or reads data from the HDDs 70a1 to 70an, and outputs a signal and data related to the reading or the writing process from or to the HDDs 70a1 to 70an (for example, the signal that indicates a location in the disk on which data is written and the data to be written) to the first communication control interface 120 described later.

The first communication control interface 120 controls communication with a first communication control interface 140 of the disk enclosure 60, as explained later. To be specific, the first communication control interface 120 is connected to the first communication control interface 140 via the SCSI cable 4. Upon receiving the signal and the data related to the reading or the writing process from or to the HDDs 70a1 to 70an from the HDD access processor 41, the first communication control interface 120 transmits the received signal and the data to the first communication control interface 140. Furthermore, upon receiving a signals and data from the HDDs 70a1 to 70an via the first communication control interface 140, the first communication control interface 120 outputs the signal and the data to the processor 40.

The command issuing unit 42 issues a predetermined command for requesting the disk detail data on the HDDs 70a1 to 70an in batch (hereinafter, “disk detail-data requesting command”) to the disk enclosure 60, and outputs the disk detail-data requesting command to the second communication control interface 130 described later.

The second communication control interface 130 communicates with the disk enclosure 60 via another communication path different from the SCSI path for transmitting or receiving the SCSI command between the disk enclosure 60 and the disk controller 20, as described later. To be specific, the second communication control interface 130 is connected to a second communication control interface 150 via the LAN cable 5. Upon receiving the disk detail-data requesting command for requesting the disk detail data in batch from the command issuing unit 42, the second communication control interface 130 transmits the disk detail-data requesting command to the second communication control interface 150. Upon receiving a response in response to the disk detail-data requesting command (for example, the disk detail data on the HDDs 70a1 to 70an) from the returning unit 92 via the second communication control interface 150, the second communication control interface 130 outputs the response to a predetermined location within the processor 40 or within the storage unit 50. A protocol such as a transmission control protocol/internet protocol (TCP/IP) is used as a communication protocol between the second communication control interface 130 and the second communication control interface 150.

The disk enclosure 60 includes the HDDs 70a1 to 70an, the first communication control interface 140, the second communication control interface 150, the processor 90 that includes the disk detail-data acquiring unit 91 and the returning unit 92, and the storage unit 100 that includes the disk detail-data storage unit 101. Same numerals are assigned to units performing the operations similar to those according to the first and the second embodiments. The explanation for such units is not repeated (the HDDs 70a1 to 70an and the returning unit 92 are explained briefly, though), and only the first communication control interface 140, the second communication control interface 150 are explained below. The second communication control interface 150 corresponds to “communication unit” described in the claims.

The HDDs 70a1 to 70an write data to the built-in disk or read the written data from the disk by using the magnetic head. The HDDs 70a1 to 70an output the signal and the data related to the reading and the writing process from or to the built-in disk (for example, the signal for notifying completion of the writing of data to a specified location and the data that is read from the specified location) to the first communication control interface 140, as described later.

The first communication control interface 140 controls communication with the first communication control interface 120. To be specific, upon receiving, from each of the HDDs 70a1 to 70an, the signal and the data related to the reading or the writing process carried out from or to the built-in disk of the HDDs 70a1 to 70an, the first communication control interface 140 transmits the signal and the data to the first communication control interface 120. In addition, upon receiving, from the first communication control interface 120, the signal and the data related to the reading and the writing process from or to the HDDs 70a1 to 70an, the first communication control interface 140 outputs the received data and signal to one of the HDDs 70a1 to 70an corresponding to the process.

In response to the disk detail-data requesting command issued by the disk controller 20, the returning unit 92 returns the disk detail data on the HDDs 70a1 to 70an in batch via the later explained second communication control interface 150.

The second communication control interface 150 communicates with the disk controller 20 via the above communication path different from the SCSI path for transmitting or receiving the SCSI command between the disk enclosure 60 and the disk controller 20. To be specific, upon receiving a response to the disk detail-data requesting command (for example, the disk detail data on the HDDs 70a1 to 70an) from the returning unit 92, the second communication control interface 150 transmits the response to the second communication control interface 130. Upon receiving a predetermined command for controlling or managing the disk array system 110 from the second communication control interface 130, the second communication control interface 150 outputs the predetermined command to the processor 90 or a specified location within the storage unit 100.

As described above, two communication paths, one is exclusively used for the signal and the data related to the reading and writing process and the other is exclusively used for the disk detail-data requesting command are explained. However, the usage of the two communication paths is not limited to the above example. For example, it is allowable to mainly use one of the two communication paths like the system according to the first embodiment, it means that not to select one depending on types of data, and use the other one when a communication failure happens via the communication path that is mainly used.

According to the second embodiment, the disk enclosure communicates with the disk controller via the communication path different from the SCSI path that is used for transmitting or receiving the SCSI command between the disk controller and the disk enclosure, and returns the disk detail data. This makes it possible to transmitting or receiving the disk detail-data requesting command or the disk detail data even if the communication failure happens via the SCSI path. Furthermore, the SCSI path can be exclusively used for reading and writing the data, not interrupted by transmitting or receiving the disk detail data, which makes it possible to enhance a processing speed of reading and writing of the data.

Although only the disk detail data is returned according to the first and the second embodiments, the transfer rate of the disk enclosure is returned along with the disk detail data according to a third embodiment of the present invention.

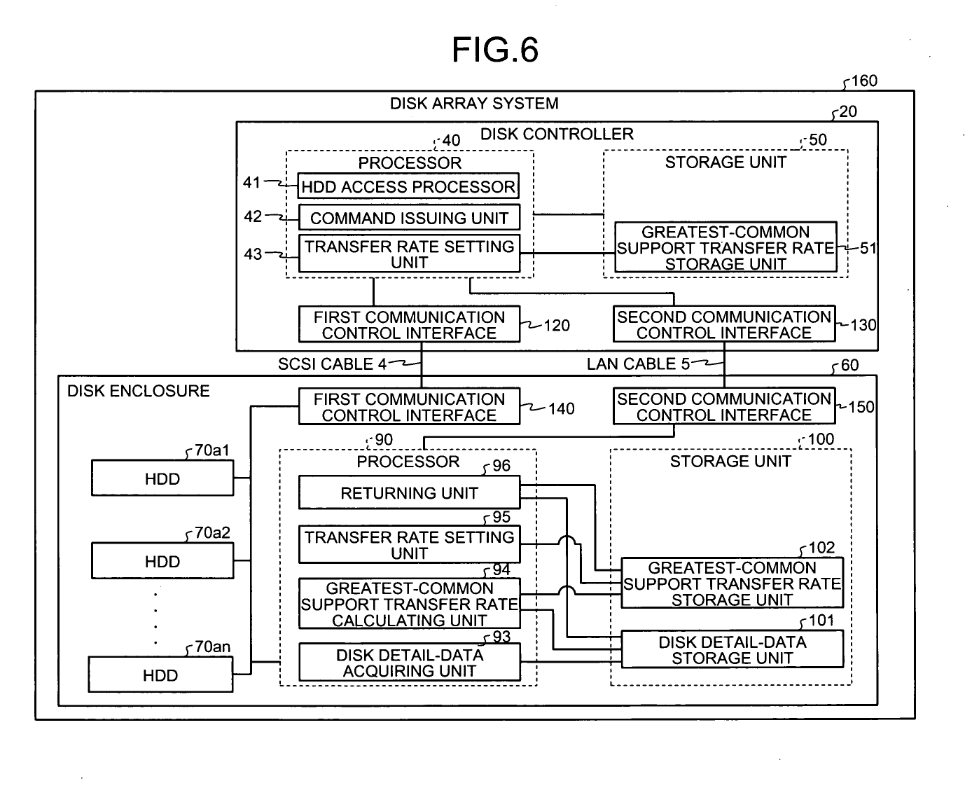

FIG. 6 is a functional block diagram of a disk array system 160 according to the third embodiment. As shown in FIG. 6, the disk array system 160 includes the disk controller 20 and the disk enclosure 60, both connected to each other via the SCSI cable 4 and the LAN cable 5.

The disk enclosure 60 stores the HDDs 70a1 to 70an, the first communication control interface 140, the second communication control interface 150, the processor 90 that includes a disk detail-data acquiring unit 93, a greatest-common support transfer rate calculating unit 94, a transfer rate setting unit 95, and a returning unit 96, and the storage unit 100 that includes the disk detail-data storage unit 101 and a greatest-common support transfer rate storage unit 102. Same numerals are assigned to units performing the operations similar to those according to the first and the second embodiments. The explanation for such units is not repeated, and the disk detail-data acquiring unit 93, the greatest-common support transfer rate calculating unit 94, the transfer rate setting unit 95, the returning unit 96, and the greatest-common support transfer rate storage unit 102 are explained below. The disk detail-data acquiring unit 93, the greatest-common support transfer rate calculating unit 94, the transfer rate setting unit 95, the returning unit 96, and the second communication control interface 150 correspond to “acquiring unit”, “selecting unit”, “setting unit”, “returning unit”, and “communication unit”, described in the claims, respectively.

The disk detail-data acquiring unit 93 issues the SCSI command to each of the HDDs 70a1 to 70an to acquire, particularly according to the third embodiment, the support transfer rate of each of the HDDs 70a1 to 70an in addition to the disk detail data on the HDDs 70a1 to 70an.

The greatest-common support transfer rate calculating unit 94 calculates a greatest-common support transfer rate from the support transfer rate of each of the HDDs 70a1 to 70an. For example, if the support transfer rates are 1 giga byte per second (GB/sec) and 2 GB/sec for the HDD 70a1, 1 GB/sec, 2 GB/sec, and 4 GB/sec for the HDD 70a2, and 1 GB/sec, 2 GB/sec, and 4 GB/sec for the HDD 70a3, the greatest-common support transfer rate is 2 GB/sec that is a greatest and common transfer rate among those for the HDDs 70a1, 70a2, and 70a3.

The transfer rate setting unit 95 sets a transfer rate between the disk enclosure 60 and each of the HDDs 70a1 to 70an to the greatest-common support transfer rate that is calculated by the greatest-common support transfer rate calculating unit 94.

In response to the SCSI command issued by the disk controller 20, the returning unit 96 returns the greatest-common support transfer rate in addition to the disk detail data on the HDDs 70a1 to 70an in batch.

The greatest-common support transfer rate storage unit 102 stores therein the greatest-common support transfer rate that is calculated by the greatest-common support transfer rate calculating unit 94. Detailed processes performed by the above units are explained later with reference to a flowchart.

The disk controller 20 controls the disk array system 160 in such a manner that the disk array system 160 works as a storage device to or from which an external data processor can write or read data. The disk controller 20 includes the first communication control interface 120, the second communication control interface 130, the processor 40 that internally includes the HDD access processor 41, the command issuing unit 42, and a transfer rate setting unit 43, and the storage unit 50 that includes a greatest-common support transfer rate storage unit 51. Same numerals are assigned to units performing the operations similar to those according to the first and the second embodiments. The explanation for such units is not repeated, and the transfer rate setting unit 43 and the greatest-common support transfer rate storage unit 51 are explained below. The transfer rate setting unit 43 corresponds to “setting unit” described in the claims.

The transfer rate setting unit 43 sets the transfer rate between the disk controller 20 and the disk enclosure 60 to the greatest-common support transfer rate received from the returning unit 96.

The greatest-common support transfer rate storage unit 51 stores therein the greatest-common support transfer rate that is received from the disk enclosure 60. Detailed process performed by the above units is explained later with reference to a flowchart.

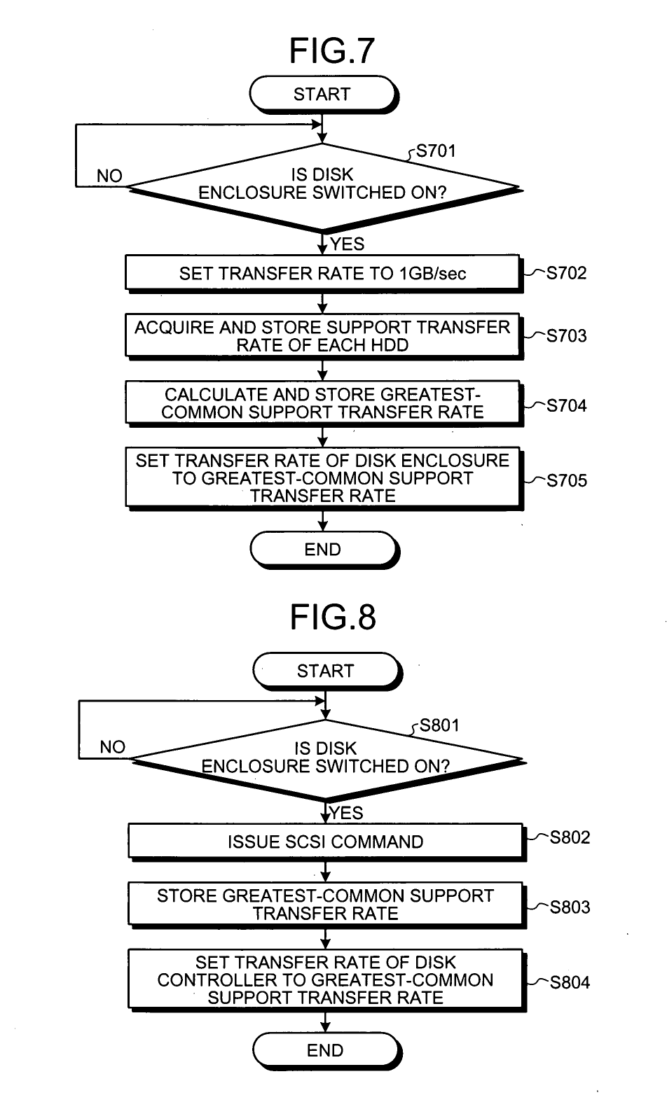

The process performed by the by the disk enclosure 60 according to the third embodiment is explained below with reference to FIG. 7. FIG. 7 is a flowchart of the process performed by the disk enclosure 60 according to the third embodiment.

When the disk enclosure 60 is switched on (or the predetermined operation is performed after the disk enclosure 60 is switched on) (Yes at step S701), the transfer rate setting unit 95 temporarily sets the transfer rate of the disk enclosure 60 to 1 GB/sec (step S702). The disk detail-data acquiring unit 93 issues the SCSI command to each of the HDDs 70a1 to 70an to receive the disk detail data and the support transfer rate from each of the HDDs 70a1 to 70an, and stores the disk detail data and the support transfer rate in the disk detail-data storage unit 101 (step S703). The greatest-common support transfer rate calculating unit 94 calculates the greatest-common support transfer rate from the support transfer rate of each of the HDDs 70a1 to 70an stored in the disk detail-data storage unit 101, and stores the greatest-common support transfer rate in the greatest-common support transfer rate storage unit 102 (step S704). After the transfer rate setting unit 95 reads the greatest-common support transfer rate from the greatest-common support transfer rate storage unit 102 and sets the transfer rate of the disk enclosure 60 to the greatest-common support transfer rate (step S705), the process control goes to end. Upon receiving the SCSI command that is issued by the disk controller 20, the returning unit 96 returns the disk detail data and the greatest-common support transfer rate that is stored in the greatest-common support transfer rate storage unit 102 in response to the SCSI command.

The process performed by the disk controller 20 according to the third embodiment is explained below with reference to FIG. 8. FIG. 8 is a flowchart of the process performed by the disk controller 20 according to the third embodiment.

When the disk controller 20 is switched on (or the predetermined operation is performed after the disk controller 20 is switched on) (Yes at step S801), the command issuing unit 42 issues the SCSI command for requesting the disk detail data on the HDDs 70a1 to 70an in batch to the disk enclosure 60 (step S802). Upon receiving the disk detail data and the greatest-common support transfer rate from the returning unit 96 via the second communication control interface 150 in response to the SCSI command, and the second communication control interface 130 stores the greatest-common support transfer rate in the greatest-common support transfer rate storage unit 51 (step S803). After the transfer rate setting unit 43 reads the greatest-common support transfer rate from the greatest-common support transfer rate storage unit 51 to set the transfer rate for accessing the disk enclosure 60 to the greatest-common support transfer rate (step S804), the process control goes to end.

According to the third embodiment, the disk enclosure acquires the support transfer rate of each of the HDDs, calculates the greatest-common support transfer rate from support transfer rate of each of the HDDs, sets the transfer rate between the disk enclosure and each of the HDDs to the greatest-common support transfer rate, returning the greatest-common support transfer rate to the disk controller 20 in addition to the disk detail data on the HDDs in batch in response to the SCSI command that is issued by the disk controller. The disk controller sets the transfer rate between the disk controller and the disk enclosure to the greatest-common support transfer rate. With such a system, it is possible to automatically and rapidly set the transfer rate of the entire system.

According to the third embodiment, the disk enclosure communicates with the disk controller via the communication path different from the SCSI path that is used for transmitting or receiving the SCSI command between the disk enclosure and the disk controller, returns the greatest-common support transfer rate in addition to the disk detail data. This makes it possible to receive the SCSI command, the disk detail data, and the greatest-common support transfer rate even if a communication failure happens via the SCSI path.

Although exemplary embodiments of the present invention are explained as described above, various modifications can be applied. Exemplary modifications are explained below.

### (1) SCSI Command

The SCSI command for requesting the disk detail data on the HDDs in batch is issued according to the above embodiments. Other than the command for requesting the disk detail data in batch, it is allowable to issue, when a predetermined situation happens, the SCSI command for requesting the disk detail data to one of the HDDs. To be specific, instead of issuing the SCSI command to the disk enclosure 60, the SCSI command for requesting the disk detail data, the disk controller 20 directly issues the SCSI command for requesting the disk detail data to one of the HDD 70a1 to 70an. This makes it possible to flexibly acquire disk detail data, which enhances the performance of the system.

### (2) Returning the Greatest-Common Support Transfer Rate

The greatest-common support transfer rate is returned in addition to the disk detail data in response to the SCSI command according to the above embodiments. However, it is allowable to return the greatest-common support transfer rate in response to another SCSI command (for example, an SCSI command related to settings of the system) that is different from the SCSI command for requesting the disk detail data in batch.

### (3) Communication Protocol

Although the TCP/IP is used in the communication path different than the SCSI path according to the above embodiments, another protocol such as a user datagram protocol/internet protocol (UDP/IP) can be used.

### (4) System Configuration

The constituent elements of the device shown in the drawings are merely conceptual, and need not be physically configured as illustrated. The constituent elements, as a whole or in part, can be separated or integrated either functionally or physically based on various types of loads or use conditions, for example, separating the disk detail-data storage unit 101 into the disk detail-data storage unit and the greatest-common support transfer rate storage unit. The process functions performed by the device are entirely or partially realized by the CPU or computer programs that are analyzed and executed by the CPU, or realized as hardware by wired logic.

Of the processes described in the embodiments, all or part of the processes explained as being performed automatically can be performed manually. Similarly, all or part of the processes explained as being performed manually can be performed automatically by a known method. According to the embodiments, when the disk controller is switched on in a state that the communication between the disk controller and the disk enclosure is established, the operations start automatically. However, the operation can be started when the predetermined operation is performed. The processing procedures, the control procedures, specific names (for example, “first” or “second” that is added to the head of the communication control interface), various data, and information including parameters described in the embodiments or shown in the drawings can be changed as required unless otherwise specified.

### (5) Disk Array Program

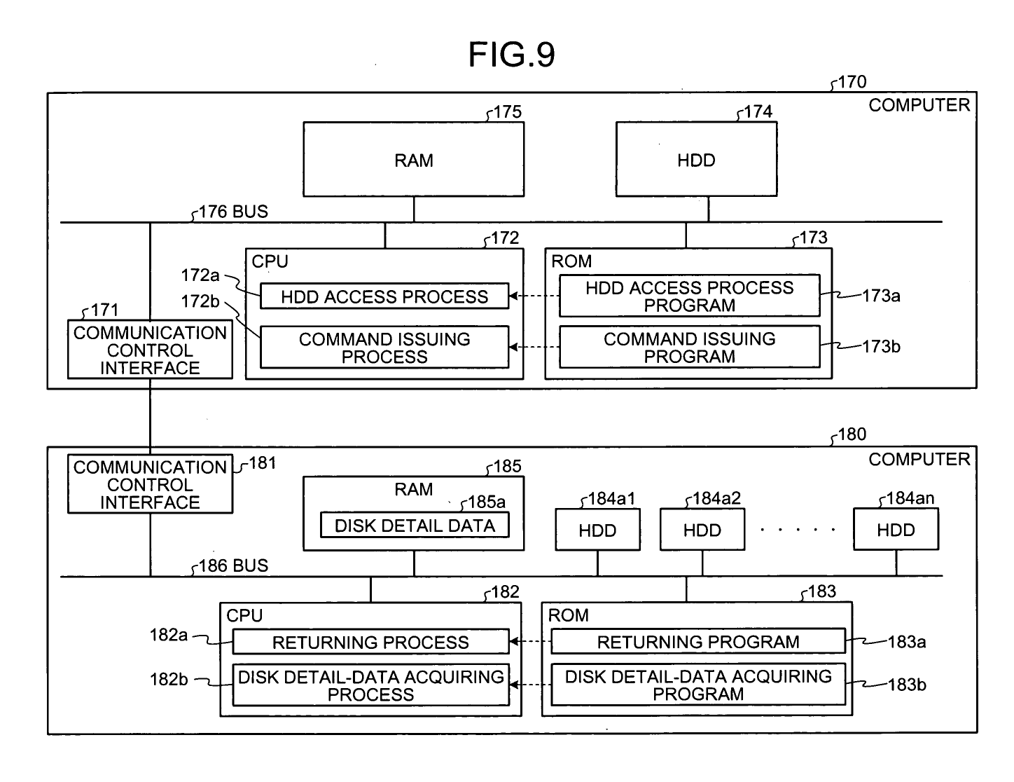

The various processes are realized as hardware by using logic according to the first embodiment. However, the processes can be realized by executing a program prepared in advance by a computer. An example of such a computer that executes a disk array program that causes the computer to implement functions similar to those of the disk array system 10 according to the first embodiment is explained below. FIG. 9 is a block diagram of the computer that executes the disk array program.

As shown in FIG. 9, a computer 170 working as the disk controller includes a communication control interface 171, a central processing unit (CPU) 172, a read-only memory (ROM) 173, an HDD 174, and a random access memory (RAM) 175, those connected to each other via a bus 176.

Disk control programs, in other words, an HDD access process program 173a and a command issuing program 173b are preinstalled in the ROM 173 that cause the computer 170 to function as the disk controller 20 according to the first embodiment. The HDD access process program 173a and the command issuing program 173b can be integrated or separated appropriately, as is the constituent elements of the disk controller 20 shown in FIG. 2.

When the CPU 172 reads and execute the HDD access process program 173a and the command issuing program 173b from the ROM 173, the HDD access process program 173a and the command issuing program 173b function as an HDD access process 172a and a command issuing process 172b, respectively. The HDD access process 172a and the command issuing process 172b correspond to the HDD access processor 41 and the command issuing unit 42 shown in FIG. 2, respectively.

A computer 180 working as the disk enclosure includes a communication control interface 181, a CPU 182, a ROM 183, HDDs 184a1 to 184an, and a RAM 185, those connected to each other via a bus 186.

Disk enclosure programs, in other words, a return program 183a and a disk detail data acquiring program 183b are preinstalled in the ROM 183 that causes the computer 180 to function as the disk enclosure 60 according to the first embodiment. The return program 183a and the disk detail data acquiring program 183b can be integrated or separated appropriately, as is the constituent elements of the disk enclosure 60 shown in FIG. 2.

When the CPU 182 reads and executes the return program 183a and the disk detail data acquiring program 183b, the return program 183a and the disk detail data acquiring program 183b function as a return process 182a and a disk detail data acquiring process 182b, respectively. The return process 182a and the disk detail data acquiring process 182b correspond to the returning unit 92 and the disk detail-data acquiring unit 91 shown in FIG. 2, respectively.

The CPU 182 performs the process as the disk enclosure based on disk detail data 185a stored in the RAM 185.

It is unnecessary that the ROM 173 or the ROM 183, the HDD access process program 173a and the command issuing program 173b or the return program 183a and the disk detail data acquiring program 183b are stored beforehand in the ROM 173 or the ROM 183. The above programs can also be stored in a portable physical medium such as a flexible disk (FD), a compact disk-read only memory (CD-ROM), a magneto-optical (MO) disk, a digital versatile disk (DVD), and an integrated circuit (IC) card that can be inserted into the computer 170 or the computer 180, or in a fixed physical medium such as an HDD provided inside or outside the computer 170 or the computer 180, or in another computer (or server) connected to the computer 170 or the computer 180 via a public circuit, the Internet, a LAN, a wide area network (WAN), etc. The computer 170 or the computer 180 reads the above programs from the above medium or the computer to execute the programs.

According to an embodiment of the present invention, regardless of the number of the disk devices, the optimum system can be constructed within a short time by acquiring the disk detail data of all the disk devices using a simple process.

Furthermore, even if a communication failure happens via the SCSI path, the disk enclosure can transmit or receive an SCSI command or the disk detail data. Because the SCSI path can be exclusively used for reading and writing of data, the transmitting or receiving of the SCSI command or the disk detail data can be carried out smoothly, which makes it possible enhance a processing speed of reading and writing of data.

Moreover, the disk detail data can be acquired flexibly, which makes it possible to enhance performance of the system.

Furthermore, a transfer rate of the entire system can be set automatically and rapidly.

Moreover, even if a communication failure happens via the SCSI path, the SCSI command, the disk detail data, and a greatest-common support transfer rate can be transmitted or received via another communication path.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A disk array system comprising:
a disk enclosure that houses a plurality of disk devices; and
a disk controller that controls reading of data from and writing of data to the disk devices, wherein the disk controller and the disk enclosure communicate with each other via a first communication path,
the disk enclosure includes
an acquiring unit that issues a first command to each of the disk devices, and receives disk detail data from each of the disk devices in response to the first command via a first communication path;
a storage unit that stores therein the disk detail data; and
a returning unit that returns the disk detail data stored in the storage unit in batch in response to a second command received from the disk controller, and
the disk controller including a command issuing unit that issues the second command to the disk enclosure.

2. The disk array system according to claim 1, wherein
the disk enclosure further includes a communication unit that communicates with the disk controller via a second communication path, and
the returning unit returns the disk detail data via the second communication path.

3. The disk array system according to claim 1, wherein the disk controller further includes an individual command issuing unit that issues a third command to one of the disk devices for requesting the disk detail data.

4. The disk array system according to claim 1, wherein
the acquiring unit acquires at least one support transfer rate from each of the disk devices,
the disk enclosure further includes
a selecting unit that selects a greatest-common support transfer rate out of the support transfer rates of the disk devices; and
a first setting unit that sets a transfer rate between the disk enclosure and each of the disk devices to the greatest-common support transfer rate,
the returning unit returns the greatest-common support transfer rate to the disk controller in response to the second command that is issued by the disk controller, and
the disk controller further includes a second setting unit that sets a transfer rate between the disk controller and the disk enclosure to the greatest-common support transfer rate received from the returning unit.

5. The disk array system according to claim 4, wherein
the disk enclosure further includes a communication unit that communicates with the disk controller via a second communication path, and
the returning unit returns the greatest common divisor to the disk controller via the second communication path.

6. A disk array system comprising:
a disk enclosure that houses a plurality of disk devices; and
a disk controller that controls reading of data from and writing of data to the disk devices, wherein the disk controller and the disk enclosure communicate with each other by using various small computer system interface (SCSI) commands via a first communication path,
the disk enclosure includes
an acquiring unit that issues a first SCSI command to each of the disk devices, and receives disk detail data from each of the disk devices in response to the first SCSI command;
a storage unit that stores therein the disk detail data; and
a returning unit that returns the disk detail data in batch in response to a second SCSI command received from the disk controller, and
the disk controller including a command issuing unit that issues the second SCSI command to the disk enclosure.

7. The disk array system according to claim 6, wherein
the disk enclosure further includes a communication unit that communicates with the disk controller via a second communication path, and
the returning unit returns the disk detail data via the second communication path.

8. The disk array system according to claim 6, wherein the disk controller further includes an individual command issuing unit that issues a third SCSI command to one of the disk devices for requesting the disk detail data.

9. The disk array system according to claim 6, wherein
the acquiring unit acquires a support transfer rate from each of the disk devices,
the disk enclosure further includes
a selecting unit that selects a greatest-common support transfer rate out of the support transfer rates of the disk devices; and
a first setting unit that sets a transfer rate between the disk enclosure and each of the disk devices to the greatest-common support transfer rate,
the returning unit returns the greatest-common support transfer rate to the disk controller in response to the second SCSI command that is issued by the disk controller, and
the disk controller further includes a second setting unit that sets a transfer rate between the disk controller and the disk enclosure to greatest-common support transfer rate received from the returning unit.

10. The disk array system according to claim 9, wherein
the disk enclosure further includes a communication unit that communicates with the disk controller via a second communication path, and
the returning unit returns the greatest common divisor to the disk controller via the second communication path.

11. A computer-readable recording medium that stores therein a computer program that causes a disk enclosure and a disk controller to function as a computer, the disk enclosure housing a plurality of disk devices, and the disk controller controlling reading of data from and writing of data to the disk devices, wherein the disk controller and the disk enclosure communicate with each other via a first communication path,
the computer program causing the disk enclosure to execute
issuing a first command to each of the disk devices, and receiving disk detail data from each of the disk devices in response to the first command via a first communication path;
storing the disk detail data in a storage unit; and
returning the disk detail data stored in the storage unit in batch in response to a second command received from the disk controller, and
the computer program causing the disk controller execute issuing the second command to the disk enclosure.

12. A method of controlling a disk enclosure and a disk controller, the disk enclosure housing a plurality of disk devices, and the disk controller controlling reading of data from and writing of data to the disk devices, wherein the disk controller and the disk enclosure communicate with each other via a first communication path, wherein
the disk enclosure performs
issuing a first command to each of the disk devices, and receiving disk detail data from each of the disk devices in response to the first command via a first communication path;
storing the disk detail data in a storage unit; and
returning the disk detail data stored in the storage unit in batch in response to a second command received from the disk controller, and
the disk controller performs issuing the second command to the disk enclosure.

13. The method according to claim 12, wherein
the disk enclosure further performs communication with the disk controller via a second communication path, and
the returning includes returning the disk detail data via the second communication path.

14. The method according to claim 12, wherein the disk controller further performs issuing a third command to one of the disk devices for requesting the disk detail data.

15. The method according to claim 12, wherein
the acquiring includes acquiring at least one support transfer rate from each of the disk devices,
the disk enclosure further performs
selecting a greatest-common support transfer rate out of the support transfer rates of the disk devices; and
setting a transfer rate between the disk enclosure and each of the disk devices to the greatest-common support transfer rate,
the returning includes returning the greatest-common support transfer rate to the disk controller in response to the second command that is issued by the disk controller, and
the disk controller further performs setting a transfer rate between the disk controller and the disk enclosure to the greatest-common support transfer rate received from the returning unit.

16. The method according to claim 15, wherein
the disk enclosure further performs communication with the disk controller via a second communication path, and
the returning includes returning the greatest common divisor to the disk controller via the second communication path.
